(19) United States
(12) Patent Application Publication
(10) Pub. No.: US 2014/0317060 A1
(43) Pub. Date: Oct. 23, 2014

(54) REMOTE BACKUP OF LARGE FILES

(71) Applicant: Intronis, Inc., Chelmsford, MA (US)

(72) Inventors: Lina Shen, Acton, MA (US); Steven Frank, Maynard, MA (US); Hui Meng, Shanghai (CN)

(73) Assignee: Intronis, Inc., Chelmsford, MA (US)

(21) Appl. No.: 14/256,341

(22) Filed: Apr. 18, 2014

Related U.S. Application Data
(60) Provisional application No. 61/813,389, filed on Apr. 18, 2013.

(51) Int. Cl. G06F 11/14

(52) U.S. Cl. CPC G06F 11/1464
USPC 707/652

(57) ABSTRACT

A method of backing up large volumes of data that includes identifying a data file for remote backup; transmitting two or more chunks of the data file in parallel through a communications network to a server to be stored by the server; streaming, compressing, and encrypting prior to transmission each chunk without generating additional data copies for each of the streaming, compressing, and encrypting; detecting an interruption in the transmission a chunk(s); checking the availability and reliability of the communications network; and restarting transmission of the interrupted chunk after a randomized pause period.

### CROSS-REFERENCE TO RELATED APPLICATIONS

This application claims the benefit of U.S. Provisional Patent Application Ser. No. 61/813,389 filed on Apr. 18, 2013, the contents of which are hereby incorporated by reference in their entirety.

### TECHNICAL FIELD

The subject matter described herein relates to remote backup of large files.

### BACKGROUND

As the amount of digital data on a server increases, completing a successful data backup becomes harder. Backup applications with millions of files to examine become overwhelmed, and network and computer processing limitations can throttle throughput when transferring a very large file (e.g., a file that is hundreds of megabytes, gigabytes, terabytes, or more). Even if a backup job is successful, the data in a large file may have changed in the hours it took to create the backup image.

Storage device interfaces limit data transfer. For example, a fast disk drive or gigabit Ethernet network can transfer only a few dozen megabytes of data per second, and most are far slower. At that speed, copying the entire contents of a 300 GB disk drive from a host or client to a remote server can easily take several hours, if not tens of hours to complete. Additionally, an interruption in Internet connection between the host and backup server requires a file backup job to restart from the beginning of the file because all previous progress is lost. As files get larger, backup job completion times also increase, increasing the likelihood that an interruption in Internet connection will occur. Therefore, a backup job for a very large file may never actually complete.

### SUMMARY

In a first aspect, a computer-implemented method of backing up large volumes of data is disclosed. According to some embodiments, the method includes identifying a data file for remote backup. Subsequently, two or more chunks of the data file can be transmitted in parallel through a communications network to a server to be stored by the server. The chunks are streamed, compressed, and encrypted prior to transmission without generating additional data copies for each of the streaming, compressing, and encrypting. An interruption is detected in the transmission of a chunk(s). The availability and reliability of the communications network is checked. Transmission of the interrupted chunk(s) is restarted after a randomized pause period.

One or more of the following aspects can be included. For example, chunk size can be adjusted based on the communication network reliability. Chunk size can be reduced in response to an interruption in the transmission of a chunk(s). The communication network quality can be monitored. Chunk size can be dynamically adjusted based on the network quality. Restarting transmission of the interrupted chunk can include dividing the interrupted chunk into sub-chunks, each sub-chunk being transmitted to the server independently. All of the data file chunks can be transmitted in a combination of parallel and serial order relative to each other.

In variations and implementations of the method, a communication network connected to the system and to the server can be tested to determine throughput and quality of data communication between the system and the server. A chunk size of a file to be backed up by the server can be determined based on the determined throughput and quality of the communication network. A low quality reliability indicates the chunk size may be reduced, and a high quality reliability indicates the chunk size may be increased. In other implementations, checking the availability and reliability of the communication network includes pinging a backup server and/or another server; measuring reliability using latency of a single ping; and measuring throughput using multiple pings.

In a second aspect, articles of manufacture that include computer executable instructions permanently stored (e.g., non-transitorily stored, etc.) on computer readable media, which, when executed by a computer, cause the computer to perform operations described herein are also described. More specifically, some embodiments of this aspect include an article of manufacture having machine readable instructions that include identifying a data file for remote backup; transmitting in parallel two or more chunks of the data file through a communications network to a server to be stored by the server, the chunks being streamed, compressed, and encrypted prior to transmission without generating additional data copies for each of the streaming, compressing, and encrypting; detecting an interruption in the transmission of a chunk(s); checking an availability and reliability of the communications network; and restarting transmission of the interrupted chunk after a randomized pause period.

Similarly, computer systems are also described that may include a processor(s) and a memory coupled to the processor(s). The memory may temporarily or permanently store a program(s) that cause the processor(s) to perform an operation(s) described herein. In addition, methods can be implemented by a data processor(s) either within a single computing system or distributed among multiple computing systems.

More specifically, a system for backing up large volumes of data is disclosed. In some embodiments, the system includes a data processor(s), memory for storing instructions, which, when executed by the data processor(s), cause the data processor(s) to perform operations. In some variations, the performed operations include testing a communication network connected to the system and a server to determine throughput and quality of data communication between the system and the server; and determining a chunk size of a file to be backed up by the server based on the determined throughput and quality of the communication network. A low quality reliability indicates the chunk size will be reduce. A high quality reliability indicates the chunk size will be increased. In other variations, the system may further include a chunk worker(s) that is assignable to a processor(s), wherein each chunk worker is structured and arranged to stream, compress, encrypt, and upload a chunk of the large volumes of data.

One or more of the following aspects can be included in or with the system. For example, each chunk worker of the plurality of chunk workers is a thread. Each chunk worker performs streaming, compressing, encrypting, and uploading either serially or in parallel. The system further includes a task assigner that is adapted to determine a number of chunk workers needed to complete a task using chunk metadata. Chunk metadata may include a physical start position and a physical end position of each chunk in the file object. Other performed operations may include identifying a data file for remote backup, which includes determining in the file object a physical start position and a physical end position of each chunk; determining a number of chunk workers needed to complete the streaming, compressing, and encrypting; and allocating each chunk to one of the chunk workers.

The subject matter described herein provides many advantages. For example, the current subject matter provides for improved methods of remotely backing up large amounts of data, especially data with large file sizes. Moreover, files such as VMware® images (manufactured by VMware, Inc. of Palo Alto, Calif.), Microsoft® Exchange database (EDB) files (manufactured by Microsoft Corporation of Redmond, Wash.), ShadowCraft images, and any other large binary files can be reliably backed up. Time required to upload files can be reduced by at least 20% and remote backup efficiency can be improved.

The details of one or more variations of the subject matter described herein are set forth in the accompanying drawings and the description below. Other features and advantages of the subject matter described herein will be apparent from the description and drawings, and from the claims.

### DESCRIPTION OF DRAWINGS

The accompanying drawings are not intended to be drawn to scale. In the drawings, each identical or nearly identical component that is illustrated in various figures is represented by a like numeral. For purposes of clarity, not every component may be labeled in every drawing. In the drawings:

FIG. 1 shows a process flow diagram of an illustrative embodiment of a method of remotely backing up a data file;

FIG. 2 shows a process flow diagram of an illustrative embodiment of a method of adjusting chunk size based on a measurement of the quality of communication connection;

FIG. 3 shows a diagram illustrating the actions of a single chunk worker serially processing a file object; and

FIG. 4 shows a diagram illustrating the actions of multiple chunk workers processing a file object in parallel.

### DETAILED DESCRIPTION

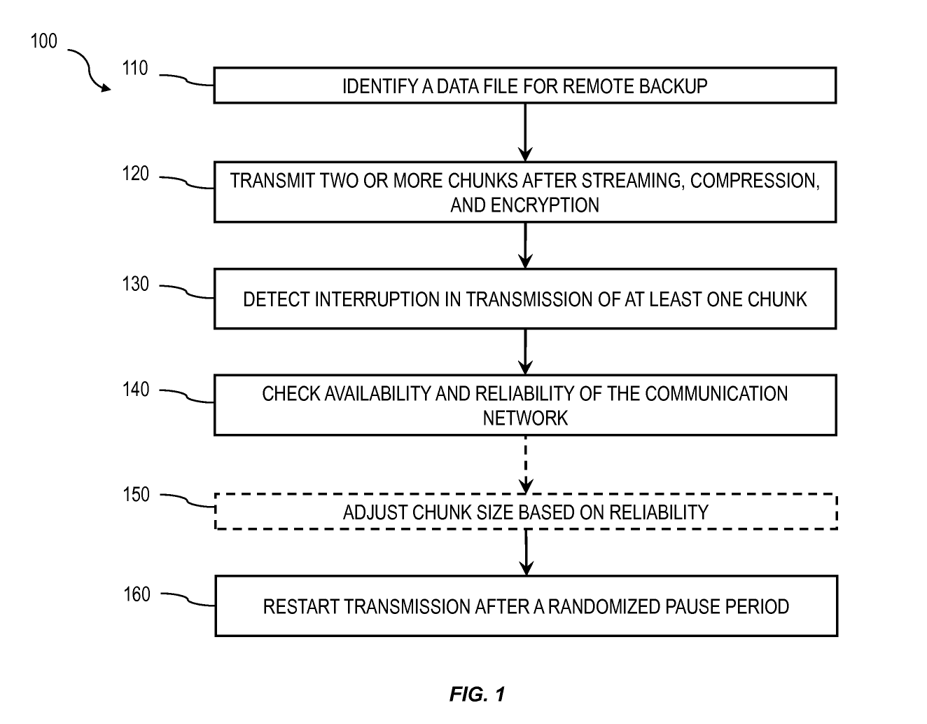

FIG. 1 shows a process flow diagram 100 describing an illustrative embodiment of a method of remotely backing up a data file. At 110, identification of a data file object for remote backup occurs at a host. For example, the data file object can be a relatively large binary file. Each data file object contains a plurality of chunks, each chunk being a contiguous portion of the file object. At 120, transmission of two or more chunks from the host to a remote backup server occurs. The transmission of each chunk occurs across a communications network (e.g., a local area network (LAN), a wide area network (WAN), the Internet, an Ethernet, and the like) connected to both the host and the backup server. The size of each chunk can be fixed or variable. Each chunk is streamed from the file object, compressed, and encrypted prior to uploading and transmission. Intermediate copies of the chunk are not created during this pre-processing.

At 130, an interruption in the transmission of at least one of the two or more chunks is detected. For example, an Internet connection does not guarantee a quality of service, and is regularly interrupted for brief periods. Therefore, a connection may be lost. In fact, over a long enough period of time, maintaining a constant connection over the Internet is very unlikely, if not impossible. At some point, there is a loss of service.

At 140, the availability and reliability of the communication network are checked. This can be checked by, for example, pinging the backup server or another server. A latency measurement of the ping can also be used to measure reliability and multiple pings can be used to measure throughput. Optionally, at 150, the size of the interrupted chunk or any additional chunks not yet transmitted can be adjusted based on the reliability measurement. In general, if the chunk is too large, there is a low probability the transmission will complete before an interruption occurs. An interruption requires the transmission to restart from the beginning of the chunk and all previous progress is lost. If the chunk is too small, the processing overhead incurred in the chunking process outweighs the benefit gained. Chunk size can be decreased in response to a low reliability measurement (i.e., high latency, a poor connection, etc.). Chunk size can be increased in response to a high reliability, which improves efficiency. Performing this adjustment for a number of chunks and data objects can provide for an optimal and dynamic chunk size, which can improve over all backup software efficiency and performance.

At 160, the transmission is restarted after a random length pause period, e.g., between approximately five and 20 minutes. Chunks transmitted prior to the interruption do not have to be resent. However, chunks in the process of being transmitted or partially transmitted at the time of interruption and before transmission was completed, i.e., interrupted chunks, can be resent in toto from the processing point at which interrupted chunks have been streamed, compressed, and encrypted. The random pause period prevents the backup server from being overwhelmed from multiple hosts simultaneously attempting to restart a transmission. Since transmission is not restarted until after an availability check has been performed, computing resources are not wasted on attempting to transmit a chunk to the server when there is no connection.

The interrupted chunk can also be further divided into sub-chunks and each sub-chunk can be transmitted independently from each other. Additionally, files can be divided into a plurality of chunks, which can be transmitted in any order.

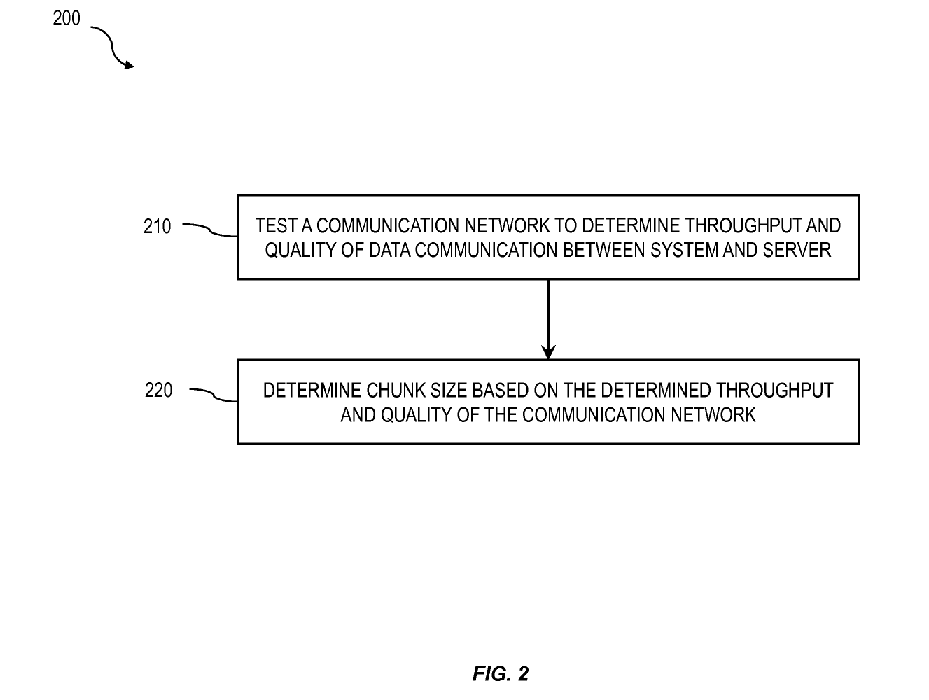

FIG. 2 shows a process flow diagram 200 describing an illustrative embodiment of a method of adjusting chunk size based on a measurement of the quality of communication connection between the host and server. At 210, a test of a communication network is performed to determine throughput and a quality of the data communication between a host and a backup server. At 220, chunk size is determined based on the determined throughput and quality measurement of the communication network. A low reliability indicates the chunk size will be reduced. A high reliability indicates the chunk size will be increased. In some embodiments, reliability, whether high or low, may be based on the number of attempts it takes to upload a chunk. For example, a connection may be considered “highly reliable” if the chunk can be written to the server in one or two attempts, while additional attempts greater than two may constitute a “low reliability” connection. The communication network can be continuously monitored and chunk size can be determined dynamically based on the communication network current conditions.

Methods of the current subject matter can be applied to any file over a predetermined size. For example, any file over 100 MB can be divided into 100 MB chunks. Each chunk can be streamed, compressed, and encrypted in parallel and/or serially. The number of parallel chunks being processed at any one time can be limited to avoid overloading the host. Each processor can be assigned a number of chunk workers (i.e., threads) to process different chunks.

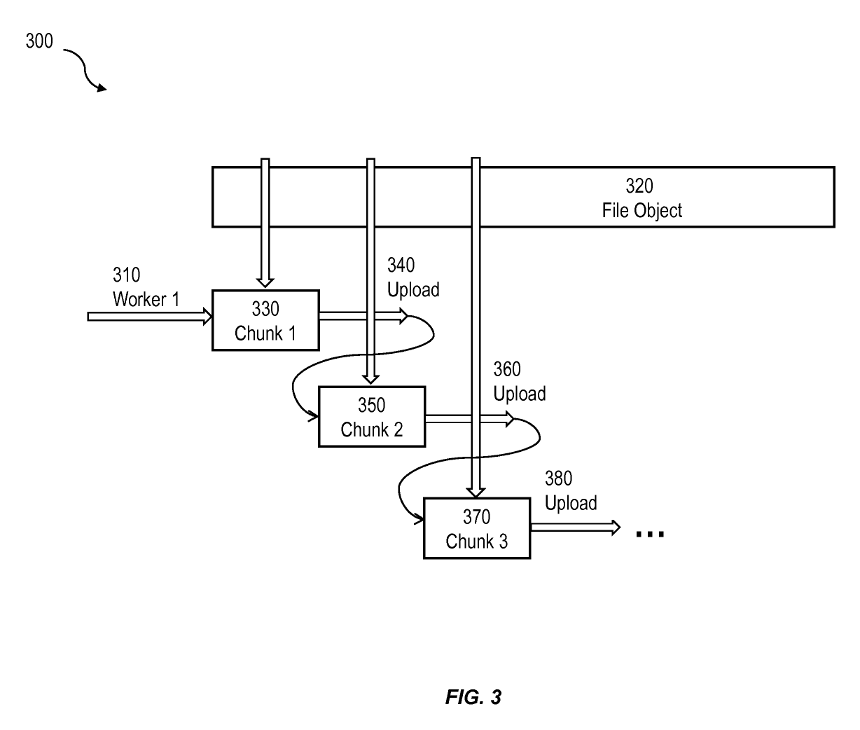

FIG. 3 shows a diagram 300 illustrating the actions of a single chunk worker 310 serially processing a data file object 320. Worker 310 streams data from the data file object 320 to create a first chunk or segment 330. The worker 310 compresses, encrypts, and uploads 340 the chunk 330 to a backup server. Then the worker 310 repeats the process by streaming data from the file object 320 to create a second chunk 350 and compresses, encrypts, and uploads 360 the chunk 350 to the backup server. The process continues until the entire file object 320 is streamed, compressed, encrypted, and uploaded to the backup server. Uploading can be performed using the subject matter described in FIG. 1.

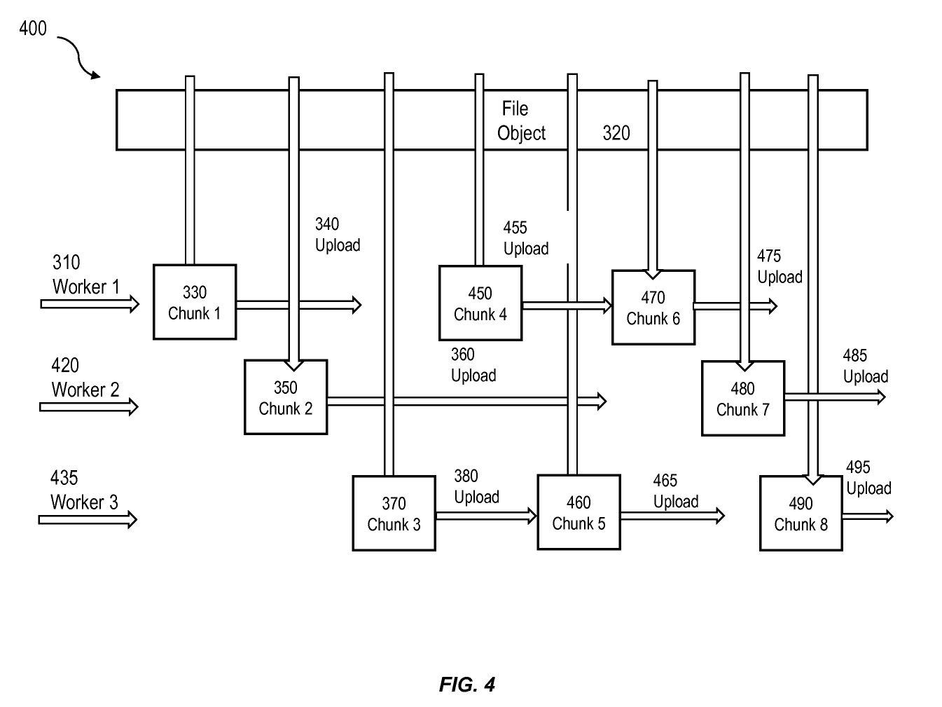

FIG. 4 shows a diagram 400 illustrating the actions of multiple (e.g., three) chunk workers 310, 420, 435 processing a data file object 320 in parallel. The first worker 310, streams data from the data file object 320 to create a first chunk or segment 330. First worker 310 compresses, encrypts, and uploads 340 the chunk 330 to a backup server. At the same time, a second worker 420 streams data from the data file object 320 to create a second chunk 350. The second worker 420 compresses, encrypts, and uploads 360 the second chunk 350 to the backup server. At the same time, a third worker 435 streams data from the data file object 320 to create a third chunk 370. The third worker 435 compresses, encrypts, and uploads 380 the third chunk 370 to the backup server. Once each worker completes uploading their respective chunk, the worker proceeds to repeat the process for a new chunk of the data file object 320. For example, once the first worker 310 has completed uploading at 340, the first worker 310 streams data from the file object 320 to create a fourth chunk 450. The first worker 310 compresses, encrypts, and uploads 455 the fourth chunk 450. This process is repeated by each worker in parallel until the entire file object 320 is streamed, compressed, encrypted, and uploaded to the backup server. Uploading can be performed using the subject matter illustrated in FIG. 1.

The host can include a system involving chunk workers, a chunk union, a to-do entry, and a to-do chunk entry. The chunk worker, described above, is a thread that performs the chunk streaming, compressing, encrypting, and uploading. The chunk union manages the number of chunk workers currently processing one or more data file objects and can add or delete chunk workers according to system resource availability and processing needs. The to-do entry specifies data file objects that currently require backup and contains multiple to-do chunk entries. Each to-do chunk entry specifies a chunk for processing and further contains chunk metadata.

Prior to task assignment by the chunk union, chunk metadata (e.g., a physical start position and a physical end position of the chunk in a data file object, and the like) are computed. The metadata are provided to the chunk union. The chunk union determines the number and allocation of chunk workers to complete all tasks. The chunk union can base the allocation on the maximum number of chunk workers allowed by the system, the total number of chunks waiting processing, and the number of chunk workers already operating. Chunk unions can also delete or remove chunk workers if the chunk worker is idle for a predefined length of time.

Various implementations of the subject matter described herein may be realized in digital electronic circuitry, integrated circuitry, specially designed ASICs (application specific integrated circuits), computer hardware, firmware, software, and/or combinations thereof. These various implementations may include implementation in one or more computer programs that are executable and/or interpretable on a programmable system including at least one programmable processor, which may be special or general purpose, coupled to receive data and instructions from, and to transmit data and instructions to, a storage system, at least one input device, and at least one output device.

These computer programs (also known as programs, software, software applications or code) include machine instructions for a programmable processor, and may be implemented in a high-level procedural and/or object-oriented programming language, and/or in assembly/machine language. As used herein, the term “machine-readable medium” refers to any computer program product, apparatus and/or device (e.g., magnetic discs, optical disks, memory, Programmable Logic Devices (PLDs)) used to provide machine instructions and/or data to a programmable processor, including a machine-readable medium that receives machine instructions as a machine-readable signal. The term “machine-readable signal” refers to any signal used to provide machine instructions and/or data to a programmable processor.

To provide for interaction with a user, the subject matter described herein may be implemented on a computer having a display device (e.g., a CRT (cathode ray tube) or LCD (liquid crystal display) monitor) for displaying information to the user and a keyboard and a pointing device (e.g., a mouse or a trackball) by which the user may provide input to the computer. Other kinds of devices may be used to provide for interaction with a user as well; for example, feedback provided to the user may be any form of sensory feedback (e.g., visual feedback, auditory feedback, or tactile feedback); and input from the user may be received in any form, including acoustic, speech, or tactile input.

The subject matter described herein may be implemented in a computing system that includes a back-end component (e.g., as a data server), or that includes a middleware component (e.g., an application server), or that includes a front-end component (e.g., a client computer having a graphical user interface or a Web browser through which a user may interact with an implementation of the subject matter described herein), or any combination of such back-end, middleware, or front-end components. The components of the system may be interconnected by any form or medium of digital data communication (e.g., a communication network). Examples of communication networks include a local area network (“LAN”), a wide area network (“WAN”), and the Internet.

The computing system may include clients and servers. A client and server are generally remote from each other and typically interact through a communication network. The relationship of client and server arises by virtue of computer programs running on the respective computers and having a client-server relationship to each other.

Although a few variations have been described in detail above, other modifications are possible. For example, the logic flow depicted in the accompanying figures and described herein does not require the particular order shown, or sequential order, to achieve desirable results. Other embodiments may be within the scope of the following claims.

What is claimed is:

1. A computer-implemented method comprising:
identifying a data file for remote backup;
transmitting in parallel two or more chunks of a plurality of data file chunks through a communications network to a server to be stored by the server, the chunks being streamed, compressed, and encrypted prior to transmission without generating additional data copies for each of the streaming, compressing, and encrypting;
detecting an interruption in the transmission of one or more chunks;
checking an availability and reliability of the communications network; and
restarting transmission of the interrupted chunk after a randomized pause period.

2. The computer-implemented method of claim 1, further comprising:
adjusting chunk size based on the communication network reliability.

3. The computer-implemented method of claim 1, wherein checking the availability and reliability of the communication network comprises:
pinging at least one of a backup server and another server;
measuring reliability using latency of a single ping; and
measuring throughput using multiple pings.

4. The computer-implemented method of claim 1, further comprising:
reducing chunk size in response to an interruption in the transmission of one or more chunks.

5. The computer-implemented method of claim 1, further comprising:
monitoring the communication network quality; and
adjusting chunk size dynamically based on the network quality.

6. The computer-implemented method of claim 1, wherein restarting transmission of the interrupted chunk includes dividing the interrupted chunk into sub-chunks, each sub-chunk being transmitted to the server independently.

7. The computer-implemented method of claim 1, wherein all of the plurality of data file chunks are transmitted in a combination of parallel and serial order relative to each other.

8. The computer-implemented method of claim 1, wherein identifying a data file for remote backup includes:
determining in the data file a physical start position and a physical end position of each chunk in the data file;
determining a number of workers needed to complete the streaming, compressing, and encrypting of each chunk; and
allocating each chunk to one of a number of chunk workers.

9. A system for backing up large volumes of data, the system comprising:
at least one data processor;
memory for storing instructions, which, when executed by the at least one data processor, cause the at least one data processor to perform operations comprising:
testing a communication network connected to the system and a server to determine throughput and quality of data communication between the system and the server; and
determining a chunk size of a data file to be backed up by the server based on the determined throughput and quality of the communication network, wherein a low quality reliability indicates the chunk size will be reduce, and a high quality reliability indicates the chunk size will be increased.

10. The system of claim 9 further comprising a plurality of chunk workers, each of which is assignable to the at least one data processor, wherein each of the plurality of chunk workers is structured and arranged to stream, compress, encrypt, and upload a chunk of the large volumes of data.

11. The system of claim 10, wherein each chunk worker of the plurality of chunk workers is a thread.

12. The system of claim 10, wherein the plurality of chunk workers performs streaming, compressing, encrypting, and uploading in one of serially and in parallel.

13. The system of claim 9 further comprising a task assigner that is adapted to determine a number of chunk workers needed to complete a task using chunk metadata.

14. The system of claim 13, wherein chunk metadata include a physical start position and a physical end position of at least one chunk in the file object.

15. An article of manufacture for backing up large volumes of data, the article of manufacture including machine readable instructions comprising:
identifying a data file for remote backup;
transmitting in parallel two or more of a plurality of chunks of the data file through a communications network to a server to be stored by the server, the chunks being streamed, compressed, and encrypted prior to transmission without generating additional data copies for each of the streaming, compressing, and encrypting;
detecting an interruption in the transmission of one or more chunks;
checking an availability and reliability of the communications network; and
restarting transmission of the interrupted chunk after a randomized pause period.
